(19) United States
(12) Patent Application Publication
(10) Pub. No.: US 2015/0232642 A1
(43) Pub. Date: Aug. 20, 2015

(54) POLYMERIC NANOPARTICLES COMPRISING TURMERIC

(71) Applicant: XEROX CORPORATION, Norwalk, CT (US)

(72) Inventors: Valerie M. Farrugia, Oakville (CA); Maria Birau, Mississauga (CA)

(73) Assignee: XEROX CORPORATION, Norwalk, CT (US)

(21) Appl. No.: 14/182,654

(22) Filed: Feb. 18, 2014

(51) Int. Cl. C08K 5/132; C09D 11/322; C09D 11/34; C09D 135/02; C09D 7/00

(52) U.S. Cl. CPC C08K 5/132; C09D 135/02; C09D 7/007; C09D 11/34; C09D 11/322

(57) ABSTRACT

Disclosed herein are latex emulsion compositions comprising water, turmeric, at least one surfactant, and at least one organic monomer, wherein the latex emulsion composition has an average particle size of less than about 250 nm. Also disclosed herein are processes for preparing a latex emulsion composition comprising water, turmeric, at least one surfactant, and at least one organic monomer, wherein the latex emulsion composition has an average particle size of less than about 250 nm. Further disclosed herein is the use of turmeric-containing latex emulsion compositions as paints, inks, toners, cosmetics, health aids, beauty aids, foods, and coatings.

### TECHNICAL FIELD

The present disclosure relates to latex emulsion compositions comprising water, turmeric, at least one surfactant, and at least one organic monomer, wherein the latex emulsion composition has an average particle size less than about 250 nm. Also disclosed herein are processes for preparing a latex emulsion composition comprising water, turmeric, at least one surfactant, and at least one organic monomer, wherein the latex emulsion composition has an average particle size less than about 250 nm. Yet further embodiments relate to the use of the latex emulsion compositions disclosed herein as paints, inks, toners, cosmetics, health aids, beauty aids, foods, and coatings.

### BACKGROUND

Turmeric is a product of a rhizomatous herbaceous perennial plant called Curcuma longa, which belongs to the ginger family Zingiberaceae and is native to South Asia. Turmeric is commonly used as a bright-yellow spice. Turmeric is also known to help fight cancer due to its major component, curcumin. Curcumin, however, is not very soluble in the bloodstream, and therefore it is not readily absorbed by cancer cells. Researchers working with curcumin, however, have found a way to create polymeric nanoparticles incorporating this anticancer compound and deliver it to cancerous tumors.

In addition to turmeric's use as a spice and potential anti-carcinogen, turmeric has found use as a coloring agent (e.g, in cosmetics and food) and therapeutic agent in Indian food for centuries. Turmeric-based herbal paints have also been reported by one Indian journal where turmeric extract was modified with oleic acid for use in the preparation of paint.

Disclosed herein are processes for incorporating turmeric into a stable latex emulsion composition via emulsion polymerization (EP) for use in various applications such as inks, toners, cosmetics, paints, and coatings, where the natural yellow color of turmeric may play the role of a natural pigment additive. The phenolic compounds in turmeric called curcuminoids may possess bio-protective properties as well as being responsible for the yellow color of the Curcuma longa root. Curcuminoids are potent antioxidants as well as excellent antimicrobial/antibacterial and antifungal agents. Those characteristics may make turmeric-containing latex emulsion compositions excellent binders for antimicrobial coatings and protective barriers. Such turmeric-containing latex emulsion compositions may find use in many other industries, such as household and decorative paints, health aids, cosmetics, and foods, for example.

While certain colorants suitable for use in latex emulsion compositions are known, an increase in the range of colorants suitable for use in latex emulsion compositions is desirable. There is a growing international trend and customer demand for materials that contain ever-increasing amounts of natural-based materials and/or materials that are biodegradable, such as turmeric. Furthermore, is it desirable for latex emulsion compositions to be easily synthesized, have appealing color, good light stability, and narrow particle size distribution.

### SUMMARY

Disclosed herein are novel latex emulsion compositions comprising water, turmeric, at least one surfactant, and at least one organic monomer, wherein the latex emulsion composition has an average particle size of less than about 250 nm. In certain embodiments, the latex emulsion composition may have an average particle size ranging from about 250 nm to about 130 nm, such as from about 200 nm to about 150 nm. In certain embodiments, the latex emulsion composition may have an average particle size less than about 190 nm.

Also disclosed herein are processes for preparing latex emulsion compositions comprising emulsifying at least one organic monomer, turmeric, and at least one surfactant in water to form an emulsion; dissolving at least one initiator in water to form an initiator solution; and combining the initiator solution and the emulsion in water to form a latex emulsion composition, wherein the latex emulsion composition has an average particle size of less than about 250 nm.

Further disclosed herein are products comprising the latex emulsion composition disclosed herein, such as inks, toners, cosmetics, paints, health and beauty aids, foods, and coating compositions.

Both the foregoing general summary and the following detailed description are exemplary only and are not restrictive of the disclosure.

### BRIEF DESCRIPTION OF THE DRAWING

FIG. 1 is a graph depicting the particle size distribution for the latex emulsion composition produced in accordance with Example 1 of the present disclosure.

### DETAILED DESCRIPTION

The main active compounds in turmeric that are thought to be responsible for giving it its yellow color are curcuminoids, which belong to the group of diarylheptanoids (or diphenylheptanoids) having an aryl-C7-aryl skeleton as shown below.

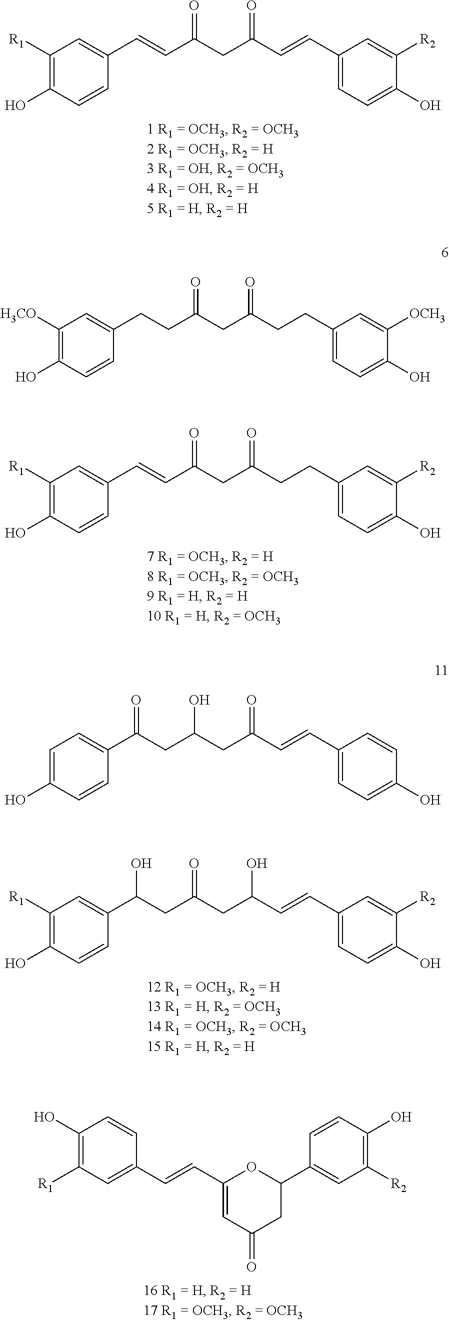

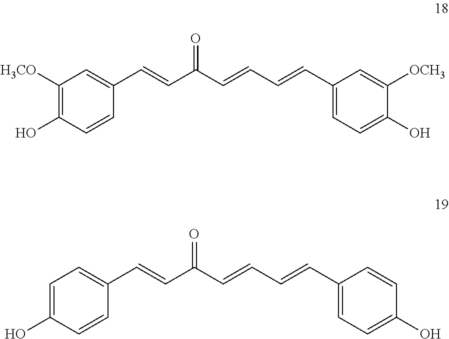 [SMILES: COc1cc(/C=C/C=C/C(=O)/C=C/c2ccc(O)c(OC)c2)ccc1O ; O=C(/C=C/C=C/c1ccc(O)cc1)/C=C/c1ccc(O)cc1]

The collective name curcuminoids refers to a mixture of three natural pigments, which include curcumin (diferuloylmethane), demethoxycurcumin, and bisdemethoxycurcumin. Curcumin is the primary component present in turmeric at approximately 3.14%.

Other important components in turmeric include volatile oils such as turmerone, atlantone, and zingiberene, as well as common sugars, proteins, and resins.

Shown below as a ketone-enol equilibrium are the principal curcuminoids of turmeric.

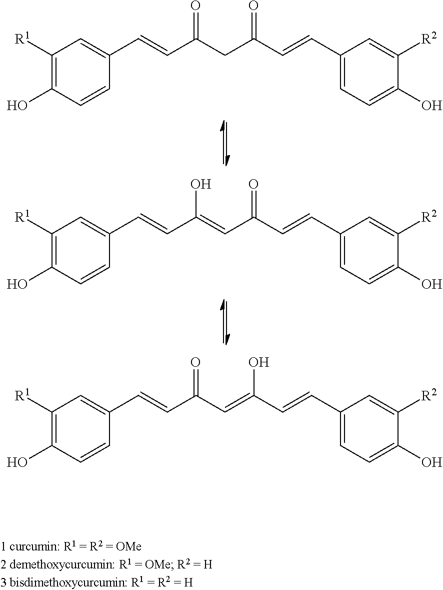

Other isolated compounds found in turmeric may include, for example, three types of diarylpentanoids (or diphenylpentanoids) comprising a five-carbon chain between two phenyl groups (20-22), six monomeric phenylpropenes (23-28), vanillic acid (29), and vanillin (30).

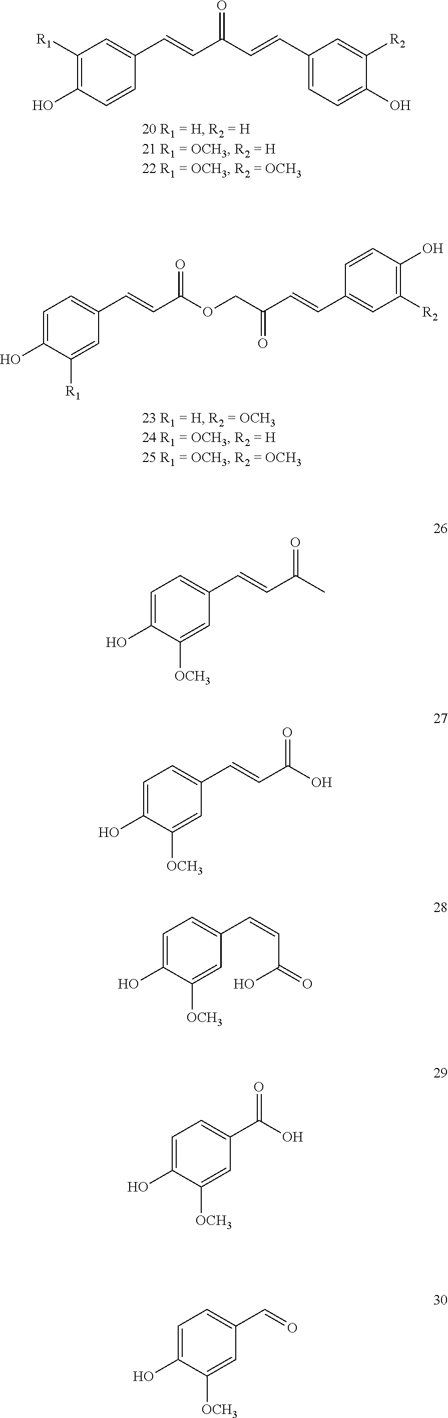

In certain embodiments, turmeric may be dissolved in a monomer feed and be easily incorporated within latex particles. For example, in certain embodiments disclosed herein, the incorporation of the turmeric compounds in styrene/n-butyl acrylate latex may be accomplished with minimal to no fouling. One skilled in the art would recognize that an increased amount of turmeric particles may be used to give a brighter and/or more intense yellow color to the latex emulsion composition. Natural yellow pigmented latex particles may be prepared by incorporating turmeric into a monomer feed emulsified with water and at least one surfactant.

Turmeric is comprised of primarily phenolic compounds and terpenoids that are water insoluble but can be dissolved well in ethanol, methanol, acetone, and dimethysulfoxide. Accordingly, dissolving turmeric in a monomer emulsion may be straightforward to one of ordinary skill in the art. A monomer feed comprising turmeric particles may, in certain embodiments, be metered into an aqueous medium to eventually form nanosized monodispersed polymer beads. The end product emulsion of polymerized latex and/or dried latex powder material may, in certain embodiments, result in a yellow colored formulation.

Turmeric is insoluble in water and difficult to disperse in an aqueous solution; therefore coating turmeric via emulsion polymerization may improve proccessability. Numerous processes are within the purview of those skilled in the art for the preparation of inks, toners, cosmetics, paints, and other coating compositions. Emulsion aggregation (EA) is one such method. The compositions disclosed herein may be formed by aggregating a colorant, such as turmeric, with a latex polymer formed by emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. In certain embodiments, the process of emulsion polymerization comprises forming an emulsion of at least one surfactant and at least one monomer in water, then polymerizing the at least one monomer in the presence of at least one water-soluble initiator. Emulsion polymerization is a well-known industrial process. For example, in forming toner compositions for use with reprographic or xerographic print devices, emulsion aggregation processes are known. Emulsion/aggregation/coalescing processes for the preparation of toners are also well known in the art.

According to embodiments disclosed herein, latex emulsion compositions comprising turmeric may be synthesized to have characteristics including good lightfastness, bright color, and narrow particle size distribution. As used herein, lightfastness refers to the ability of the color of the ink (for example, during storage or in the printed image) to remain the original color without degradation or fading of the color through exposure to light and the environment. Certain exemplary embodiments disclosed herein exhibit improved lightfastness over other known compositions incorporating turmeric as a colorant.

Various prints may be tested for lightfastness by any method known in the art. For example, prints may be tested for lightfastness with a Suntest XLS+ available from Atlas Material Testing Solutions. The relative fading resistances of the prints may be qualitatively assessed using a relatively low dose of about 1 hour exposure and Black Standard Temperature (BST) of about 50° C., and transmission of about 380 to about 720 nanometers, such that the total exposed energy may be about 2,520 KJ/m². Percent densities (e.g., 200% and 100%) of various prints may then be compared before and after lightfastness testing.

In certain embodiments, the latex emulsion composition disclosed herein may have an average particle size less than about 250 nm. For example, in certain embodiments the latex emulsion composition may have an average particle size ranging from about 250 nm to about 130 nm, such as from about 200 nm to about 150 nm, from about 145 nm to about 240 nm, from about 155 nm to about 220 nm, from about 165 nm to about 200 nm, or from about 175 nm to about 190 nm. In certain embodiments, the latex emulsion composition may have an average particle size less than about 220 nm, such as less than about 200 nm, less than about 190 nm, or less than about 175 nm.

In certain embodiments, about 3 wt % turmeric compound relative to the overall latex formulation may result in a pale yellow formulation. A higher wt % of turmeric may result in a brighter yellow colored formulation, while a lesser wt % of turmeric may result in an even paler yellow colored formulation. One skilled in the art could adjust the wt % of turmeric accordingly to arrive at the desired color. For example, in certain embodiments, the latex emulsion composition may comprise less than about 1 wt % turmeric nanoparticles, such as less than about 0.5 wt % or an amount ranging from about 0.5 wt % to about 3 wt % based on the total weight of the latex emulsion composition. In certain embodiments, the latex emulsion composition may comprise more than about 3 wt % turmeric nanoparticles, such as more than about 4 wt %, more than about 5 wt %, more than about 10 wt %, more than about 15 wt %, or more than about 25 wt %, based on the total weight of the latex emulsion composition. In certain embodiments, the latex emulsion composition may comprise turmeric nanomparticles in an amount ranging from about 3 wt % to about 5 wt %, about 5 wt % to about 10 wt %, about 10 wt % to about 15 wt %, or about 15 wt % to about 25 wt %, based on the total weight of the latex emulsion composition.

In certain embodiments, the latex emulsion composition may be used to formulate a phase change ink composition. In general, phase change inks (sometimes referred to as solid inks or “hot melt inks”) are in the solid phase at ambient temperature, but exist in the liquid phase at the elevated operating temperature of an ink jet printing device. At the jet operating temperature, droplets of liquid ink are ejected from the printing device and, when the ink droplets contact the surface of the recording substrate, either directly or via an intermediate heated transfer belt or drum, they quickly solidify to form a predetermined pattern of solidified ink drops. Phase change inks have also been used in other printing technologies, such as gravure printing.

Phase change inks for color printing typically comprise a phase change ink carrier composition that is combined with a phase change ink compatible colorant. In a specific embodiment, a series of colored phase change inks can be formed by combining ink carrier compositions with compatible subtractive primary colorants. Phase change inks may be desirable for ink jet printers because they remain in a solid phase at room temperature during shipping, long-term storage, and the like. In addition, the problems associated with nozzle clogging as a result of ink evaporation with liquid ink jet inks are largely eliminated, thereby improving the reliability of the ink jet printing. Further, in phase change ink jet printers wherein the ink droplets are applied directly onto the final recording substrate (for example, paper, transparency material, and the like), the droplets solidify immediately upon contact with the substrate, so that migration of ink along the printing medium is prevented and dot quality is improved.

Compositions suitable for use as phase change ink carrier compositions are known in the art. Suitable carrier materials can include, for example, paraffins, microcrystalline waxes, polyethylene waxes, ester waxes, fatty acids and other waxy materials, fatty amide containing materials, sulfonamide materials, resinous materials made from different natural sources (tall oil rosins and rosin esters, for example), synthetic resins, oligomers, polymers, and copolymers.

Examples of the phase change inks disclosed herein are inks that include an ink vehicle that is solid at temperatures of about 23° C. to about 27° C., for example room temperature, and specifically are solid at temperatures below about 60° C. However, the inks change phase upon heating, and are in a molten state at jetting temperatures. Thus, the inks have a viscosity ranging from about 1 to about 20 centipoise (cp), for example from about 5 to about 15 cp or from about 8 to about 12 cp, at an elevated temperature suitable for ink jet printing, for example temperatures of from about 60° C. to about 150° C.

In this regard, the inks disclosed herein may be either low energy inks or high energy inks. Low energy inks are solid at a temperature below about 40° C. and have a viscosity ranging from about 1 to about 20 centipoise, such as from about 5 to about 15 centipoise, for example from about 8 to about 12 cp, at a jetting temperature of from about 60° C. to about 100° C., such as about 80° C. to about 100° C., for example from about 90° C. to about 100° C. High energy inks are solid at a temperature below about 40° C. and have a viscosity of from about 5 to about 15 centipoise at a jetting temperature of from about 100° C. to about 180° C., for example from about 120° C. to about 160° C. or from about 125° C. to about 150° C.

The latex emulsion compositions disclosed herein comprise at least one organic monomer. Any suitable organic monomer known in the art may be used. Suitable monomers useful in forming a latex emulsion include, but are not limited to, styrenes, acrylates, methacrylates, butadienes, isoprenes, acrylic acids, methacrylic acids, acrylonitriles, combinations thereof, and the like. Exemplary organic monomers may include styrene, butyl acrylate, methacrylic acid, di(ethyleneglycol) dimethacrylicate, and beta-carboxyethyl acrylate. The at least one organic monomer may be added to the latex emulsion composition in any amount, such as for example an amount ranging from 0.01% to 99% by weight of the total latex emulsion composition.

The latex emulsion compositions disclosed herein comprise at least one initiator. Examples of suitable initiators include water soluble initiators, such as ammonium persulfate, sodium persulfate and potassium persulfate, and organic soluble initiators including organic peroxides and azo compounds including Vazo peroxides, such as VAZO 64®, 2-methyl 2-2′-azobis propanenitrile, VAZO 88®, 2-2′-azobis isobutyramide dehydrate, and combinations thereof. Other water-soluble initiators which may be utilized include azoamidine compounds, for example 2,2′-azobis(2-methyl-N-phenylpropionamidine)dihydrochloride, 2,2′-azobis[N-(4-chlorophenyl)-2-methylpropionamidine]dihydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine]dihydrochloride, 2,2′-azobis[2-methyl-N-2-propenylpropionamidine]dihydrochloride, 2,2′-azobis[N-(2-hydroxy-ethyl)2-methylpropionamidine]dihydrochloride, 2,2′-azobis[2(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis{2-[1-(2-hydroxyethyl)-2-imidazolin-2-yl]propane}dihydrochloride, combinations thereof, and the like. Initiators can be added in suitable amounts, such as from about 0.1 to about 8 weight percent, from about 0.5 to about 4 weight percent of the monomers.

In certain embodiments, the latex emulsion compositions disclosed herein can optionally comprise at least one dispersant. Any suitable or desired dispersant can be employed. In certain embodiments, amphipathic dispersants comprising a polar head group comprising multiple amine groups and a long chain, non-polar tail can be selected. In certain embodiments, polyethyleneimine based dispersants, which have terminal or secondary amines that can combine with the free acid groups on the synergist can be selected. In certain embodiments, the dispersant can be a polyethyleneimine dispersant. In certain embodiments, the dispersant can be a polyethyleneamine based dispersant, such as such as Solsperse® 13240 available from The Lubrizol Corporation. In certain embodiments, the dispersant can be selected to steer the color of the resultant emulsion composition.

The latex emulsion compositions disclosed herein may include at least one surfactant. Any suitable surfactant known in the art may be used. In certain exemplary embodiments, for example, the surfactant may be Rhodafac®. Additional suitable surfactants for use herein include anionic surfactants, nonionic surfactants, silicone surfactants and fluorosurfactants. Examples of anionic surfactants may include sulfosuccinates, disulfonates, phosphate esters, sulfates, sulfonates, and the like, and mixtures thereof. Examples of nonionic surfactants may include polyvinyl alcohol, polyacrylic acid, isopropyl alcohol, acetylenic diols, octyl phenol ethoxylate, branched secondary alcohol ethoxylates, perfluorobutane sulfonates and alcohol alkoxylates, and the like, and mixtures thereof. The at least one surfactant may be present in the latex emulsion composition in any amount desirable. For example, in certain embodiments, the at least one surfactant may be present in an amount ranging from about 0.001 wt % to about 5 wt %, such as from about 0.01 wt % to about 3 wt % or from about 0.1 wt % to about 1 wt %, based on the total weight of the latex emulsion composition. In certain embodiments, the at least one surfactant may be present in an amount ranging from about 4 wt % to about 5 wt %, such as about 4.5 wt %.

The latex emulsion compositions disclosed herein may further include any suitable or desired synergist. As used herein, a synergist is a compound containing functional groups that may promote the attachment of the dispersant to the colorant or the pigment to be dispersed. A synergist can comprise another colorant or pigment, having a similar or identical structure to the colorant or pigment to be dispersed. In certain embodiments, the synergist may, for example, be chosen from Indigo Carmine and copper phthalocyanine derivatives.

The synergist can be provided in the latex emulsion composition in any suitable or desired amount. In certain exemplary embodiments, the synergist can be present in an amount ranging from about 1 to about 300 percent, or from about 10 to about 200 percent, or from about 30 to about 150 percent total synergist, based on the total weight of the pigment in the latex emulsion composition.

The latex emulsion compositions disclosed herein can further comprise at least one wax. The latex emulsion compositions can include any suitable ink vehicle such as paraffins, microcrystalline waxes, polyethylene waxes, ester waxes, amides, fatty acids and other waxy materials, fatty amide containing materials, sulfonamide materials, resinous materials made from different natural sources (tall oil rosins and rosin esters, for example), and many synthetic resins, oligomers, polymers, and copolymers such as further discussed below.

In certain embodiments, the latex emulsion compositions herein include a polyalkylene wax. In specific embodiments, the wax is a polymethylene wax, a polyethylene wax, or a mixture of combination thereof. In certain embodiments, the latex emulsion compositions herein include a biodegradable wax. In embodiments, the biodegradable wax is a biodegradable polyethylene wax. For example, the wax can be a biodegradable polyethylene wax sold under the name Accumelt® 78 from IGI Waxes.

In certain exemplary embodiments, the latex emulsion compositions disclosed herein further comprise a low melting wax. In embodiments, the low melting wax is a polyalkylene wax, a functional wax, or a combination thereof. The term “functional wax” is known to one of skill in the art and can mean herein any suitable functional wax, in embodiments, including, but not limited to, a wax with polar groups, for example, alcohols, amides, esters, urethanes, etc. As used herein, the term “low melting wax” includes any suitable low melting wax, including, in embodiments, a wax having a melting point of less than about 120° C. Examples of suitable amides include, for example, diamides, triamides, tetra-amides, cyclic amides, and the like, including, for example, fatty amides such as monoamides, tetra-amides, and mixtures thereof.

The wax can be present in the latex emulsion composition in any suitable or desired amount. For example, the wax may be present in the latex emulsion composition in an amount ranging from about 25 percent to about 65 percent by weight based on the total weight of the latex emulsion composition. In certain embodiments, the wax is a low melting wax present in the latex emulsion composition in an amount ranging from about 25% to less than about 65% by weight based on the total weight of the ink carrier.

Optionally, at least one plasticizer, which can be either a solid or liquid plasticizer, such as benzyl phthalates, triaryl phosphate esters, pentaerythritol tetrabenzoate, dialkyl adipate, dialkyl phthalates, dialkyl sebacate, alkyl benzyl phthalates, ethylene glycol monostearate, glycerol monostearate, propylene glycol monostearate, dicyclohexyl phthalate, diphenyl isophthalate, triphenyl phosphate, dimethyl isophthalate, and mixtures thereof, or the like can also be included in the latex emulsion compositions disclosed herein. The plasticizer may be present in the latex emulsion composition in any desired or effective amount, such as from about 0.05% by weight of the composition. Examples of suitable plasticizers include Santicizer® 278, Santicizer® 154, Santicizer® 160, Santicizer® 261 (commercially available from Monsanto), and the like or mixtures thereof.

A hindered amine antioxidant can optionally be present in the latex emulsion composition disclosed herein in any desired or effective amount, such as from about 0.001 percent to about 0.50 percent by weight of the total latex emulsion composition. A hindered phenol antioxidant can also be provided. In one embodiment the hindered phenol is present in a relatively high concentration. A high concentration of hindered phenol antioxidant maximizes long-term thermal stability by delaying the onset of the oxidation itself. The hindered phenol antioxidant is present in the composition in any desired or effective amount, for example in embodiments ranging from about 0.01% to about 4.0% by weight of the total composition. Specific examples of suitable hindered phenol antioxidants include Ethanox® 330, Ethanox® 310, Ethanox® 314, Ethanox® 376 (commercially available from Albemarle) and the like. Also commercially available from Ciba Specialty Chemicals are Irganox® 1010, Irganox® 1035, Irganox® 1076, Irganox® 1330 and the like. Mixtures of two or more of these hindered phenol antioxidants can also be employed.

A rosin ester resin, mixtures thereof, or the like can also be included in the turmeric-based latex emulsion composition. The rosin ester resin is present in any desired or effective amount, in embodiments from 0.5% to about 20% by weight of the total composition. Examples of suitable rosin ester resins include Pinecrystal® KE-100 (commercially available from Arakawa), and the like.

The latex emulsion compositions disclosed herein can optionally contain any suitable or desired additional colorant selected from the group consisting of traditional dyes, pigments, and mixtures and combinations thereof, in addition to the turmeric colorant. If more than one colorant is included, the total amount of colorant present in the latex emulsion composition can be any desired or effective amount to obtain the desired color or hue, in embodiments from about 0.1 to about 50 percent, or from about 0.1 percent to about 20 percent total colorant by weight based on the total weight of the latex emulsion composition.

Any desired or effective colorant can be employed as the optional additional colorant in the latex emulsion composition, including dyes, pigments, mixtures thereof, and the like, provided that the colorant can be dissolved or dispersed in the vehicle. The compositions can be used in combination with conventional colorant materials, such as Color Index (C.I.) Solvent Dyes, Disperse Dyes, modified Acid and Direct Dyes, Basic Dyes, Sulphur Dyes, Vat Dyes, and the like.

Examples of suitable dyes include Neozapon® Red 492 (BASF); Orasol® Red G (Pylam Products); Direct Brilliant Pink B (Oriental Giant Dyes); Direct Red 3BL (Classic Dyestuffs); Supranol® Brilliant Red 3BW (Bayer AG); Lemon Yellow 6G (United Chemie); Light Fast Yellow 3G (Shaanxi); Aizen Spilon Yellow C-GNH (Hodogaya Chemical); Bemachrome Yellow GD Sub (Classic Dyestuffs); Cartasol® Brilliant Yellow 4GF (Clariant); Cibanone Yellow 2G (Classic Dyestuffs); Orasol® Black RLI (BASF); Orasol® Black CN (Pylam Products); Savinyl Black RLSN (Clariant); Pyrazol Black BG (Clariant); Morfast® Black 101 (Rohm & Haas); Diaazol Black RN (ICI); Thermoplast® Blue 670 (BASF); Orasol® Blue GN (Pylam Products); Savinyl Blue GLS (Clariant); Luxol Fast Blue MBSN (Pylam Products); Sevron Blue 5GMF (Classic Dyestuffs); Basacid® Blue 750 (BASF); Keyplast Blue (Keystone Aniline Corporation); Neozapon® Black X51 (BASF); Classic Solvent Black 7 (Classic Dyestuffs); Sudan Blue 670 (CI. 61554) (BASF); Sudan Yellow 146 (CI. 12700) (BASF); Sudan Red 462 (CI. 26050) (BASF); C.I. Disperse Yellow 238; Neptune Red Base NB543 (BASF, C.I. Solvent Red 49); Neopen® Blue FF-4012 (BASF); Fastol® Black BR (CI. Solvent Black 35) (Chemische Fabriek Triade BV); Morton Morplas Magenta 36 (CI. Solvent Red 172); metal phthalocyanine colorants, and the like. Polymeric dyes can also be used, such as those commercially available from, for example, Milliken & Company as Milliken Ink Yellow 869, Milliken Ink Blue 92, Milliken Ink Red 357, Milliken Ink Yellow 1800, Milliken Ink Black 8915-67, uncut Reactint® Orange X-38, uncut Reactint® Blue X-17, Solvent Yellow 162, Acid Red 52, Solvent Blue 44, and uncut Reactint® Violet X-80.

Pigments are also suitable optional additional colorants for the latex emulsion compositions disclosed herein. Examples of suitable pigments may include, for example, Paliogen® Violet 5100 (BASF); Paliogen® Violet 5890 (BASF); Heliogen® Green L8730 (BASF); Lithol® Scarlet D3700 (BASF); Sunfast® Blue 15:4 (Sun Chemical); Hostaperm® Blue B2G-D (Clariant); Hostaperm® Blue B4G (Clariant); Spectra® PAC C Blue 15:4 (Sun Chemical); Permanent Red P-F7RK; Hostaperm® Violet BL (Clariant); Lithol® Scarlet 4440 (BASF); Bon Red C (Dominion Color Company); Oracet® Pink RF (BASF); Paliogen® Red 3871 K (BASF); Sunfast® Blue 15:3 (Sun Chemical); Paliogen® Red 3340 (BASF); Sunfast® Carbazole Violet 23 (Sun Chemical); Lithol® Fast Scarlet L4300 (BASF); Sunbrite® Yellow 17 (Sun Chemical); Heliogen® Blue L6900, L7020 (BASF); Sunbrite® Yellow 74 (Sun Chemical); Spectra® PAC C Orange 16 (Sun Chemical); Heliogen® Blue K6902, K6910 (BASF); Sunfast® Magenta 122 (Sun Chemical); Heliogen® Blue D6840, D7080 (BASF); Sudan Blue OS (BASF); Neopen® Blue FF4012 (BASF); PV Fast Blue B2GO1 (Clariant); Irgalite® Blue GLO (BASF); Paliogen® Blue 6470 (BASF); Sudan Orange G (Aldrich); Sudan Orange 220 (BASF); Paliogen® Orange 3040 (BASF); Paliogen® Yellow 152, 1560 (BASF); Lithol® Fast Yellow 0991 K (BASF); Paliotol® Yellow 1840 (BASF); Novoperm® Yellow FGL (Clariant); Ink Jet Yellow 4G VP2532 (Clariant); Toner Yellow HG (Clariant); Lumogen® Yellow D0790 (BASF); Suco-Yellow L1250 (BASF); Suco-Yellow D1355 (BASF); Suco Fast Yellow D1355, D1351 (BASF); Hostaperm® Pink E 02 (Clariant); Hansa Brilliant Yellow 5GX03 (Clariant); Permanent Yellow GRL 02 (Clariant); Permanent Rubine L6B 05 (Clariant); Fanal® Pink D4830 (BASF); Cinquasia® Magenta (DU PONT); Paliogen® Black L0084 (BASF); Pigment Black K801 (BASF); and carbon blacks such as Regal 330® (Cabot), Nipex 150 (Evonik) Carbon Black 5250 and Carbon Black 5750 (Columbia Chemical), and the like, as well as mixtures thereof.

Unless otherwise indicated, all numbers used in the specification and claims are to be understood as being modified in all instances by the term “about,” whether or not so stated. It should also be understood that the precise numerical values used in the specification and claims form additional embodiments of the disclosure, as do all ranges and subranges within any specified endpoints. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary.

It is to be understood that both the foregoing description and the following example are exemplary and explanatory only and are not intended to be restrictive. In addition, it will be noted that where steps are disclosed, the steps need not be performed in that order unless explicitly stated.

The accompanying figure, which is incorporated in and constitutes a part of this specification, is not intended to be restrictive, but rather illustrate embodiments of the disclosure.

Other embodiments will be apparent to those skilled in the art from consideration of the specification and practice of the disclosure.

### EXAMPLE

The following example is not intended to be limiting of the disclosure.

Turmeric was incorporated into styrene/n-butyl acrylate/methacrylic acid-based latex as an inherent colorant.

Fabrication of Styrene/n-Butyl Acrylate Latex with 0.78 mol % Turmeric

A latex emulsion composition comprised of polymer particles generated from the emulsion polymerization of styrene, n-butyl acrylate, methacrylic acid, beta-carboxyethyl acrylate and turmeric was prepared as follows.

The monomers styrene (128.5 g), butyl acrylate (39.0 g), methacrylic acid (6.0 g), curcumin (4.66 g) and ethylene glycol dimethacrylate (0.60 g) were emulsified in water (80 ml) containing 30% Rhodafac® RS 710 (26.0 g).

An initiator solution was prepared by dissolving ammonium persulfate (1 g) in deionized water (80 ml).

Deionized water (350 ml) was heated to 90° C. Then 16 ml of the initiator solution was added to the heated deionized water followed by the simultaneous addition of the remaining initiator solution and the emulsion. Emulsion addition took 27 min (10.6 g/min) while the initiator addition took 26 min (2.5 g/min). The reaction mixture was maintained at a temperature of about 90° C. for a period of about 2.5 hours and then cooled to ambient temperature. The product was discharged and sieved with a 25 μm screen. Table 1 below shows the formulation used for the latex emulsion composition that was prepared.

TABLE 1

| Monomer/ | Molecular | | | | |
|---|---|---|---|---|---|
| Surfactant/ | weight | | | | |
| Initiator | (g/moles) | Grams | Moles | Mole % | Wt. % |
| Styrene | 104.15 | 128.50 | 1.2338 | 76.02% | 71.88% |
| Butyl Acrylate | 128.17 | 39.00 | 0.3043 | 18.75% | 21.82% |
| Methacrylic acid | 86.09 | 6.00 | 0.0697 | 4.29% | 3.36% |
| Curcumin from | 368.38 | 4.66 | 0.0126 | 0.78% | 2.61% |
| Curcuma longa | | | | | |
| (Turmeric) | | | | | |
| powder | | | | | |
| Di(ethylene | 242.27 | 0.60 | 0.0025 | 0.15% | 0.34% |
| glycol) | | | | | |
| dimethacrylate | | | | | |
| Deionized water | | 80.00 | | | |
| Rhodafac ® RS | | 8.00 | | | 4.48% |
| 710 | | | | | |
| Deionized water | | 18.00 | | | |
| Deionized water | | 350.00 | | | |
| in reactor | | | | | |
| Ammonium | 228.19 | 1.00 | 0.0044 | 0.27% | 0.56% |
| persulfate | | | | | |
| Deionized water | | 80.00 | | | |
| Weight and moles | | 178.76 | 1.62 | 100.27% | 100.00% |
| of total monomers | | | | | |

The color of the latex emulsion composition was visually observed to be similar to a pale yellow, which is believed to be because only 0.78 mol % of turmeric was used.

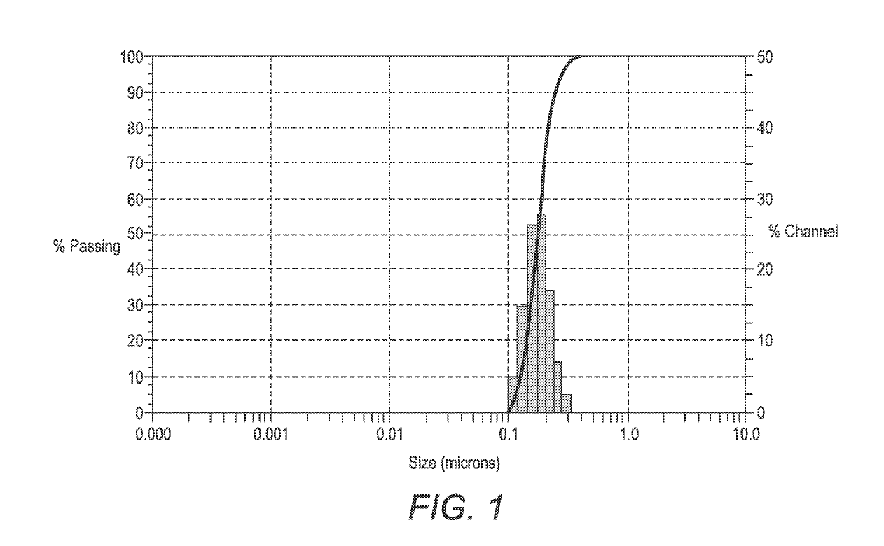

The particle size of the latex emulsion composition was then measured by a Nanotrac® U2275E particle size analyzer. The particle size of the turmeric-containing latex was 176.1 nm±0.04 nm; hence, a very narrow particle size distribution was obtained. FIG. 1 is a graph illustrating the particle size distribution of the latex emulsion composition obtained. Table 2 below shows the particle size distribution data obtained from the particle size analyzer.

TABLE 2

| Data Item | Value | Percentile | Size (um) |
|---|---|---|---|
| MV (um) | 0.1823 | 10.00 | 0.1310 |
| MN (um) | 0.1555 | 20.00 | 0.1449 |
| MA (um) | 0.1725 | 30.00 | 0.1557 |
| CS: | 34.79 | 40.00 | 0.1658 |
| SD: | 0.0424 | 50.00 | 0.1761 |
| MW: | 1.77E+09 | 60.00 | 0.1870 |
| Mz: | 0.1802 | 70.00 | 0.1996 |
| σι: | 0.0433 | 80.00 | 0.2160 |
| Ski: | 0.1966 | 90.00 | 0.2419 |
| Kg: | 1.056 | 95.00 | 0.2671 |

The latex emulsion made with 2.6 wt % (0.78 mol %) of turmeric resulted in a very appealing yellow colored powder upon drying. The latex properties were in line with a typical EA toner binder but one of ordinary skill in the art could vary the properties in terms of thermal properties, particle size, molecular weight, etc. by varying the ratio of monomers, surfactant, process etc.

What is claimed is:

1. A latex emulsion composition comprising water, turmeric, at least one surfactant, and at least one organic monomer, wherein the latex emulsion composition has an average particle size of less than about 250 nm.

2. The latex emulsion composition according to claim 1, wherein the average particle size ranges from about 130 nm to about 250 nm.

3. The latex emulsion composition according to claim 1, wherein the average particle size ranges from about 150 nm to about 200 nm.

4. The latex emulsion composition according to claim 1, wherein the average particle size is less than about 190 nm.

5. The latex emulsion composition according to claim 1, wherein the at least one organic monomer is chosen from styrene, n-butyl acrylate, and methacrylic acid.

6. The latex emulsion composition according to claim 1, further comprising at least one wax.

7. The latex emulsion composition according to claim 1, comprising at least about 2.5 wt % turmeric, based on the total weight of the latex emulsion composition.

8. The latex emulsion composition according to claim 1, comprising at least about 3 wt % turmeric, based on the total weight of the latex emulsion composition.

9. The latex emulsion composition according to claim 1, comprising at least about 5 wt % turmeric, based on the total weight of the latex emulsion composition.

10. The latex emulsion composition according to claim 1, further comprising at least one initiator.

11. A process for preparing a latex emulsion composition comprising:
emulsifying at least one organic monomer, turmeric, and at least one surfactant in water to form an emulsion;
dissolving at least one initiator in water to form an initiator solution; and
combining the initiator solution and the emulsion in water to form a latex emulsion composition,
wherein the latex emulsion composition has an average particle size of less than about 250 nm.

12. The process according to claim 11, wherein the at least one initiator is ammonium persulfate.

13. The process according to claim 11, wherein the at least one monomer is chosen from styrene, n-butyl acrylate, and methacrylic acid.

14. The process according to claim 11, wherein the initiator solution and the emulsion are added to water that is heated to about 90° C.

15. The process according to claim 11, wherein the latex emulsion composition has an average particle size ranging from about 130 nm to about 250 nm.

16. The process according to claim 11, wherein the latex emulsion composition has an average particle size particle size of less than about 200 nm.

17. The process according to claim 11, wherein the turmeric is added to the emulsion in at least about 2.5 wt %, based on the total weight of the latex emulsion composition.

18. The process according to claim 11, wherein the turmeric is added to the emulsion in at least about 3 wt %, based on the total weight of the latex emulsion composition.

19. The process according to claim 11, wherein the turmeric is added to the emulsion in at least about 5 wt %, based on the total weight of the latex emulsion composition.

20. A coating composition prepared by a process comprising:
emulsifying at least one organic monomer, turmeric, and at least one surfactant in water to form an emulsion;
dissolving at least one initiator in water to form an initiator solution; and
combining the initiator solution and the emulsion in water to form a latex emulsion composition,
wherein the latex emulsion composition has an average particle size of less than about 250 nm.
